(19) United States
(12) Patent Application Publication
(10) Pub. No.: US 2021/0028483 A1
(43) Pub. Date: Jan. 28, 2021

(54) METHOD OF THINNING AND ENCAPSULATION OF MICROELECTRONIC COMPONENTS

(71) Applicant: COMMISSARIAT A L'ENERGIE ATOMIQUE ET AUX ENERGIES ALTERNATIVES, Paris (FR)

(72) Inventor: Messaoud BEDJAOUI, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 16/935,360

(22) Filed: Jul. 22, 2020

(30) Foreign Application Priority Data
Jul. 23, 2019 (FR) 19 08320

(51) Int. Cl. H01M 10/04; H01M 10/052

(52) U.S. Cl. CPC H01M 10/0436; H01M 10/052

(57) ABSTRACT

Method of thinning and encapsulating a microelectronic component, including the following steps:
supply of an elementary structure comprising a substrate with a thickness of more than 200 μm, a microelectronic component and an adhesive layer; the adhesive layer being covered by a detachable protection layer,
fix the detachable protection layer onto a manipulation structure 100,
protection of the lateral face of the substrate,
thinning of the substrate up to a thickness of less than 100 μm,
separation of the elementary structure from the manipulation structure, for example by separating the detachable protection layer from the adhesive layer.

The method may comprise a later step during which an element comprising one or several other elementary structures is fixed onto the adhesive layer of the elementary structure, so as to form a vertical stack.

### TECHNICAL FIELD

This invention relates to the general field of thinning and encapsulation of microelectronic components such as lithium microbatteries.

The invention relates to a method of thinning a substrate covered by microelectronic components and encapsulation of these microelectronic components.

The invention also relates to a device obtained using this method.

The invention is particularly useful because it can be used to increase the capacity per unit volume of microelectronic components and/or form vertical stacks. There are many industrial fields in which the invention can be applied, and particularly the energy field and for manufacturing multifunctional autonomous systems.

### STATE OF PRIOR ART

There has been strong growth of connected objects over the last few years (IoT for “Internet of Things”). These objects sometimes require energy recovery and storage devices that have to satisfy many technological constraints: better electrical performances, more compact and with very conformable dimensions.

In the case in which these devices are microbatteries, they must have good electrochemical performances while maintaining minimum size.

There are several elements that can be modified to optimise the performances of microbatteries, specifically the shape and dimensions (design) of active layers, the nature of the electrode materials used, manufacturing methods and packaging techniques. In general, the packaging concept covers all steps that follow standard microbattery manufacturing steps grouped on the scale of a thick substrate.

In general, it is desirable to have microbatteries with a high capacity per unit volume. The capacity per unit volume is the ratio between the capacity per unit surface area and the volume of the component. To achieve this, the size of the layers called passive layers has to be reduced, particularly the encapsulation layers and interconnection layers, as opposed to layers called active layers, like electrodes that define the value of the capacity per unit surface area.

One solution known in prior art consists of stacking several individual components to amplify electrochemical performances and provide a good solution to this problem. For example, in documents US 2017/0111994 A1 and US 2009/0136839 A1, the electrical interconnection is made by creating through vias in the corners and/or on the edges of the host substrate and replacing them by electrically conducting glues. The major disadvantage of these solutions lies in the creation of fragile zones at the corners and/or the edges of the substrate. This weakening becomes more important as the substrate becomes thinner.

Another option that optimises the capacity per unit volume consists of thinning the rigid substrates used as microbattery manufacturing supports.

In the case of rigid substrates made of glass, the thinning operation is done by immersion methods or methods of spraying the back face of a substrate with an etching solution, for example with etching solutions comprising hydrofluoric acid HF (49%), or formed from a mixture of HF and hydrochloric acid HCl, or a mixture of HF, water and nitric acid.

However, one of the major problems of chemical thinning relates to the manipulation of thin or ultrathin substrates during and after thinning. Initially rigid substrates become very fragile after the thinning step and it is difficult afterwards to perform the ultimate cutting and/or integration steps.

In order to overcome these disadvantages, and as described in document WO2019/150020 A1, the substrate 20 to be thinned and comprising the microelectronic component 30 can be mounted on a thinning support 10 inert to etching solutions and comprising a rigid frame 12 and a single-face stretched adhesive 11, forming a drum-skin type structure (FIG. 1). The lateral face of the substrate 20 is protected by a lateral protection layer 60 during etching. The adhesive can be sensitive to UV or heat-sensitive. For example, the adhesive may have a very strong bond force that reduces under the effect of UVs, so that the substrate 10 can easily be removed from the thinning support 10.

However, for relatively long etching times, for example if low concentrations of etching solution are used, the etching solutions can infiltrate in peripheral zones A of the substrate 20 and at the back face of the support B, which can cause deterioration of the microbatteries and therefore reduce their electrochemical performances.

### PRESENTATION OF THE INVENTION

One purpose of this invention is to disclose a method that can be used to thin a substrate covered by a microelectronic component and to encapsulate a microelectronic component, overcoming the disadvantages of prior art, the method being simple, easy to use and protecting the integrity of components.

To achieve this, this invention discloses a method of thinning and encapsulating a microelectronic component, the method including the following steps:
supply of a substrate comprising a first principal face, a second principal face and a lateral face, the thickness of the substrate being more than 200 μm, and being covered by a microelectronic component and an adhesive layer, the adhesive layer being covered by a detachable protection layer; the substrate, the adhesive layer and the component forming an elementary structure,
fix the detachable protection layer onto a manipulation structure comprising an adhesive layer and a support frame, the adhesive film comprising a first adhesive face and a second face opposite the first adhesive face, the detachable protection layer being arranged facing the first adhesive face of the adhesive film,
deposit a lateral protection layer on the lateral face of the substrate and on the periphery of the second face of the substrate, the lateral protection layer being in contact with the first adhesive face of the adhesive film, as a result of which the substrate is assembled with the manipulation structure,
thinning of the second principal face of the substrate to a thickness of less than 100 μm, and preferably less than 50 μm,
separation of the elementary structure from the manipulation structure.

The method according to the invention is fundamentally different from prior art due to the presence of an adhesive layer leading to a particular combination of substrate thinning and encapsulation steps. The presence of the adhesive layer has many advantages for implementing the method:
it very efficiently protects the first face of the substrate and the microelectronic component from chemical etching products,
it forms an efficient protection from corrosive vapours released during the thinning method, thus protecting microelectronic components, particularly current collectors, often metallic and the anode layer of microbatteries; this protection is improved by the presence of the detachable protection layer,
it acts as an encapsulation layer in the final device, particularly against oxidants of lithiated layers,
it facilitates the release and manipulation steps of thinned substrates to perform assembly operations,
due to its adhesive nature, it makes it easy to transfer and fix another element onto the elementary structure to make vertical stacks.

Advantageously, the method may also include the following steps:
separation of the detachable protection layer from the adhesive layer,
fixing an element on the adhesive layer of the elementary structure.

According to a first advantageous variant embodiment, the element fixed on the adhesive layer is a cover.

According to a second advantageous embodiment, the element fixed on the adhesive layer comprises one or several other elementary structures, so as to form a vertical stack with the first elementary structure, each elementary structure being fixed by its adhesive layer or by its substrate, to the adhesive layer of the subjacent elementary structure. An elementary structure is fixed directly to the adhesive layer of the subjacent elementary structure. Directly means that there is no intermediate element between the two elementary structures.

This particular packaging architecture can give a device with a high capacity per unit volume.

The components can be connected in parallel or in series, depending on the orientation of the microelectronic component.

Several elementary structures can easily be stacked to form a vertical assembly, due to the presence of the adhesive layer. Such an assembly comprising in particular microbatteries with a high capacity per unit volume, while reducing the volume occupied.

Advantageously, an ultimate elementary structure is positioned on the vertical stack, the adhesive layer of the ultimate elementary structure being fixed directly to the adhesive layer of the subjacent elementary structure. The head-foot configuration is particularly advantageous because the substrate of the last elementary structure of the stack acts as the cap. There is no need to add other protection elements, which limits the volume of passive layers of the stack and increases the capacity per unit volume.

Once the assembly has been made, electrical interconnections can then be formed in the volume of the assembly. Since the assembly is compact, the formation of electrical contacts does not weaken it, which is not the case for methods according to prior art. The different elementary structures of the vertical stack can be arranged in parallel and/or in series.

Advantageously, the method also comprises a step during which openings are formed through the adhesive layer so as to make the microelectronic component accessible, and a step in which the openings are filled by an electrically conducting material as a result of which electrically conducting contacts are formed connected to the microelectronic components.

According to one advantageous embodiment, the adhesive layer is an Anisotropic Conductive Film (ACF).

Advantageously, the adhesive layer comprises a recess so as to form a cavity for the microelectronic component.

Alternatively, the adhesive layer may be discontinuous so as to form a cavity for the microelectronic component, after the element has been fixed.

According to these advantageous embodiments, the free volume thus formed around the microelectronic component can eliminate the influence of volume variations of the component related to the electrochemical activity between the two electrodes, particularly in the case of a microbattery.

Advantageously, the substrate comprises several microelectronic components, and preferably microbatteries.

Advantageously, the thickness of the adhesive layer varies from 1 to 50 μm, and preferably from 15 μm to 40 μm, for example from 15 μm to 30 μm.

Advantageously, the adhesive layer is rolled on the substrate. This can reinforce the bond of the adhesive layer on the substrate and improve its mechanical support.

The method according to the invention has many advantages.
easy release of the thinned substrate,
the final structure obtained has severally chemically thinned elementary structures, fixed and electrically connected to each other,
the vertical assembly technique results in a robust final device,
the substrate thinning step is easy to use,
the device has good electrochemical performances,
complete encapsulation of the microbatteries is compatible with the integration steps,
the protection of microelectronic devices, and in particular lithiated layers of microbatteries, from air and moisture,
there is no glue residue originating from adhesive tape fixed to microelectronic components, because in this method, the adhesive layer forms part of the final assembly, which prevents the need for additional rinsing steps that could change the integrity of the microbatteries due to the very high reactivity of water with lithiated components.

The invention also relates to a device comprising a vertical stack comprising at least one first elementary structure and one second elementary structure, each elementary structure comprising a substrate with a thickness of less than 100 μm and preferably less than 50 μm, a first principal face of the substrate being covered by a microelectronic component, preferably a microbattery, and by an adhesive layer, the second elementary structure being fixed, for example by its adhesive layer or its substrate, to the adhesive layer of the first elementary structure.

Advantageously, the vertical stack comprises an additional elementary structure, the adhesive layer of the additional elementary structure being positioned facing and fixed to the adhesive layer of the subjacent elementary structure.

The device obtained has a high capacity per unit volume, good mechanical strength and good chemical resistance to elements such as moisture and air.

Other characteristics and advantages of the invention will become clear after reading the remaining description given below.

It should be understood that the remaining description is only given to illustrate the purpose of the invention and can in no way be interpreted as a limitation of this purpose.

### BRIEF DESCRIPTION OF THE DRAWINGS

This invention will be better understood after reading the description of example embodiments given purely for information and that is in no way limitative, with reference to the appended drawings on which:

FIG. 1 described above diagrammatically represents a microbattery during a chemical etching step according to a method according to prior art,

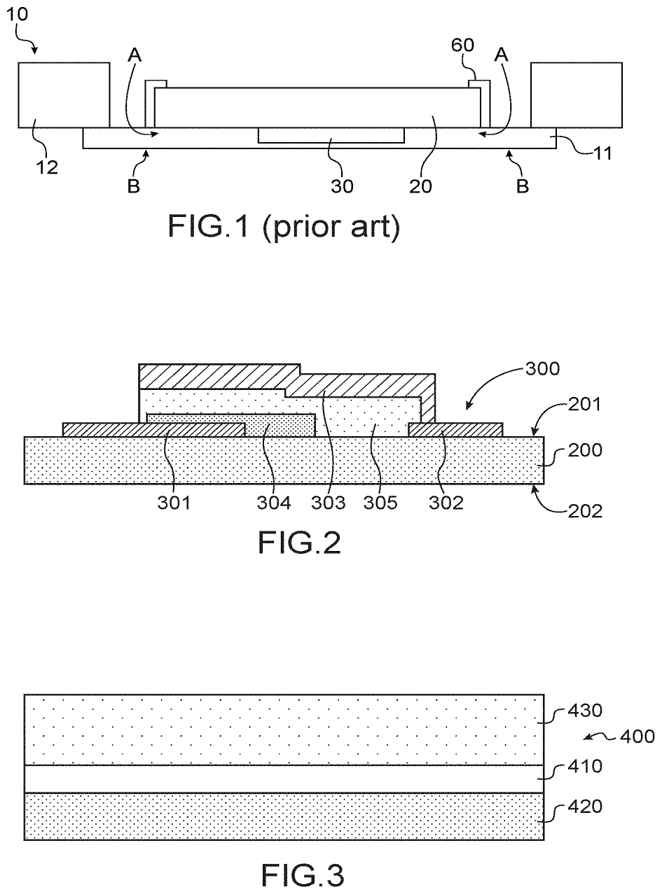

FIG. 2 diagrammatically represents a sectional view of a microbattery according to one particular embodiment of the invention,

FIG. 3 diagrammatically represents a sectional view of an adhesive layer according to one particular embodiment of the invention,

FIG. 4A and 4B diagrammatically represent sectional views of a microbattery on a substrate covered by an adhesive layer, according to different embodiments of the invention,

FIG. 5A, 5B, 6 and 7 diagrammatically represent sectional views of different steps in a method of thinning and encapsulation of a microbattery, according to one particular embodiment of the invention,

FIG. 8A, 8B, 8C, 8D and 8E diagrammatically represent sectional views of different steps in a method of vertical assembly of several microbatteries, according to one particular embodiment of the invention,

FIG. 9 diagrammatically represents a sectional view of a vertical assembly of several microbatteries connected in parallel, according to another particular embodiment of the invention,

FIG. 10 is a photographic plate of a “wafer” type substrate covered by several microbatteries, on which a double face adhesive layer and its external protection film have been added by rolling, according to one particular embodiment of the invention.

The different parts represented on the figures are not necessarily all at the same scale, to make the figures more easily understandable.

The different possibilities (variants and embodiments) must be understood as not being mutually exclusive and can be combined with each other.

Furthermore, in the following description, terms that are dependent on the orientation such as “top”, “bottom”, etc. of a structure should be understood assuming that the structure is oriented as shown on the figures.

### DETAILED PRESENTATION OF PARTICULAR EMBODIMENTS

In the following, even if the description refers to microbatteries and more particularly to lithium microbatteries, and to glass substrates, particularly in wafer form, the invention can be transposed to other microelectronic devices and particularly to any other electrochemical device, and to other natures, thicknesses and/or forms of substrates. Alternatively, the substrate could for example be made of silicon.

The method for thinning, encapsulation and vertical assembly of microbatteries includes the following steps:
manufacturing of the microbatteries 300, on a substrate 200,
transfer an adhesive layer 410, onto the substrate 200,
fix the adhesive layer 410 onto a manipulation structure 100,
thin the substrate 200 of the microbatteries 300,
separation of the microbatteries 300 from the manipulation structure 100,
vertical assembly of the microbatteries 300,
electrical interconnection of the microbatteries 300.

Step 1: Manufacturing of the microbatteries 300:

We will start by describing the method of manufacturing a microbattery 300 on a substrate 200. This is the first necessary step for preparation of the elementary structure (also called the base structure or the individual structure and denoted S).

Substrate 200:

The substrate 200 (also called the host substrate or support substrate), is preferably a rigid substrate.

A rigid substrate means any support that can easily be used in microelectronics with a thickness of more than 200 μm. For example, the thicknesses of the rigid substrate is more than 200 μm, for example 500 μm to 1 mm. For example, it may be 500 μm thick.

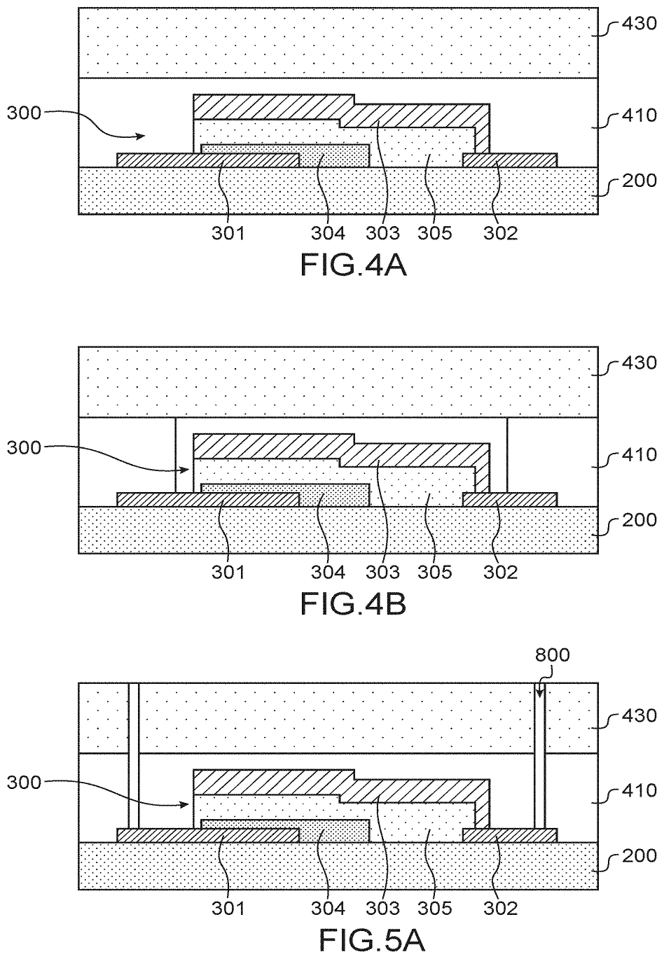

As represented on FIG. 2, the substrate 200 comprises a first principal face 201 called the active face (or front face) opposite to a second principal face (called the back face). The substrate 200 also comprises a lateral face from the first principal face 201 to the second principal face.

The substrate 200 may have different geometric shapes. For example, circular type wafer formats or sheet formats, in other words rectangular formats, can be used.

The substrate 200 advantageously has the performances required for encapsulation of lithium microbatteries. It is manufactured from a material with WVTR (“Water Vapour Transmission Rate”) and OTR (“Oxygen Transfer Rate”) barrier levels at most of 10⁻⁴ g/m²/d and 10⁻⁴ cm³/m²/d respectively to guarantee sufficient leak tightness properties against air and against water vapor.

The substrate 200 can be a material chosen from among glasses, silicon (monocrystalline or polycrystalline), ceramics, mica and quartz.

It is preferably made of glass. Such substrates are compatible with thinning methods by grinding, despite the presence of strong topography induced by stacking the active layers of the microbatteries.

The glasses used may be borosilicates (such as D263® LA, D263® M, D263® T, MEMpax® or Borofloat® marketed by SCHOTT® company), derivatives of borosilicates such as alkali-free borosilicate glasses (AF32®, AF45, Corning® Willow, etc.) or boro-aluminosilicate type glasses (“alkaline earth boro-aluminosilicates”) marketed for example by the Corning Lotus™, EAGLE XG® companies. Such substrates are perfectly adapted to methods of manufacturing lithium microbatteries.

Preferably, the substrate 200 is transparent to laser wavelengths conventionally used for the cutting steps. Transparent means that the substrate 200 allows at least 50% of the light emitted by the laser to pass through.

Microelectronic device 300:

At least one microelectronic device 300 is located on the first principal face 201 of the substrate 200.

The thickness of the microelectronic device varies from 5 μm to 30 μm, and preferably from 10 to 15 μm.

The first face 201 of the substrate 200 may comprise one or several microelectronic devices 300, for example so as to multiply electrochemical performances by putting microelectronic devices in parallel or in series. Manufacturing of several devices on the same substrate can advantageously reduce microbattery manufacturing costs. The microelectronic devices 300 may be identical or different.

A microelectronic device means a microelectronic component 300, for example such as a MEMS (microelectromechanical system), a MOEMS (microoptoelectromechanical system), an infrared microdetector, a transistor, a microbattery, a capacitor, a super capacitor, a photovoltaic component, an antenna or any other device considered necessary for manufacturing connected objects.

The microelectronic device 300 can be sensitive to air (to dioxygen and to water vapour). For example, it could be a capacitive stack or an electrochromic component.

As represented on FIG. 2, the microelectronic device 300 can be a microbattery. It comprises cathodic 301 and anodic 302 current collectors placed on the substrate 200. Two active layers, one forming the negative electrode 303 and the other forming the positive electrode 304, are separated by an electrolyte layer 305. Each active layer 303, 304 is in contact with one of the current collectors 301, 302.

The current collectors 301 and 302 are advantageously metallic. For illustration, they may be made of titanium, gold, aluminium, platinum or tungsten. For example, they may be 300 nm thick.

The positive electrode 304 (cathode) is made of a material with good electronic and ionic conductivity (for example TiOS, TiS₂, LiTiOS, LiTiS₂, LiCoO₂, V₂O₅, etc.). A positive electrode made of cobalt oxide will be chosen in preference. This type of cathode is considered to one of the highest performance layers for microbatteries and is also one of the most highly stressed during fabrication steps. Mechanical stresses generated after formation of the cathodic layer (coefficient of thermal expansion between 10×10⁻⁶/° C. and 15×10⁻⁶/° C. and a Young's modulus between 100 and 500 GPa) can have an influence on the behaviour of rigid substrates once they have been thinned.

The electrolyte 305 is an electronic insulator with high ionic conductivity (for example LiPON, LiPONB, LiSiCON, etc.).

The negative electrode 303 (anode) is a layer that can be made of metallic lithium or a lithiated material.

Optionally and depending on the configuration, the active layers can be protected by a primary encapsulation system composed of one or several elementary barrier layers, the main role of which is to guarantee the integrity of microbattery devices during the different phases of the process.

The microbattery will be made using techniques known to those skilled in the art, for example made using techniques for deposition of all-solid thin layers.

Step 2: Transfer of the adhesive layer 410:

In this second step, an adhesive layer 410 is transferred on all individual batteries 300 and the host substrate 200.

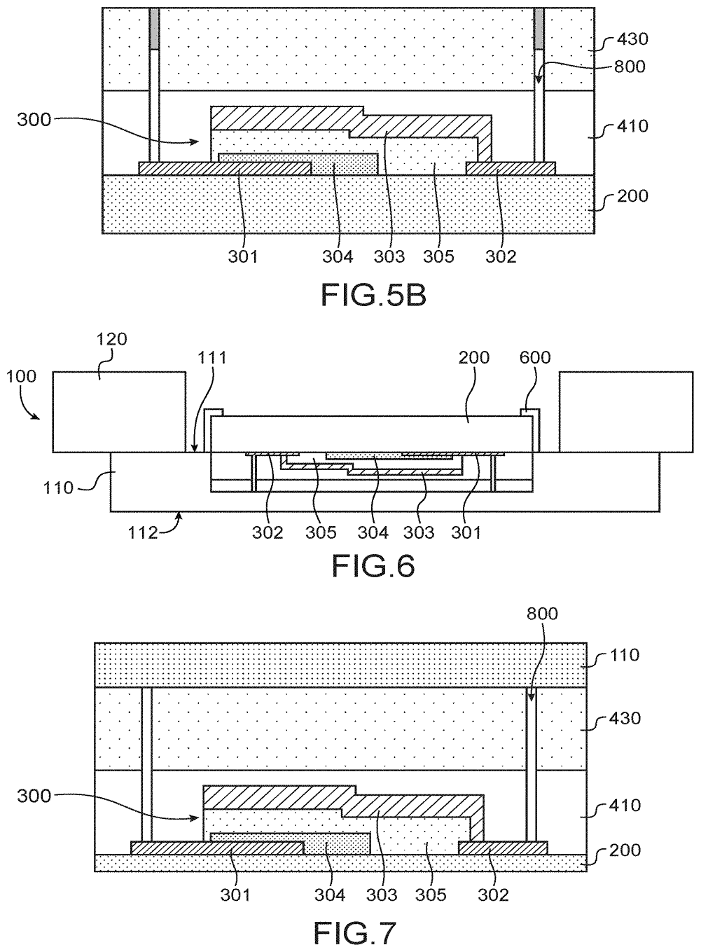

As represented on FIG. 3, the adhesive layer 410 used may for example be initially covered on each side by a protection layer called the internal layer 420 (also called the lower layer) and a protection layer called the external layer 430 (also called the upper layer). It is a double sided adhesive 400.

The protection layers 420, 430, also called “liners” are used as mechanical consolidation elements during manipulation operations of the adhesive layer 410. They are easily removable. For example, they may be PET films with a thickness of a few tens of microns to a few hundred micrometres.

The two principal faces of the adhesive layer 410, in contact with the protection layers 420, 430, are adhesive by nature.

The adhesive layer 410 may be pressure sensitive (“Pressure Sensitive Adhesive”). For example, it may be based on acrylic, silicone, rubber or a mixture of these materials.

The adhesive layer 410 will advantageously be as thin as possible to reduce the thickness of the passive layers of the basic structure and in fine to optimise the volume of the assembly of microbatteries.

For example, the total thickness of the adhesive layer 410 may be between 1 μm and 50 μm and preferably of the order of 25 μm.

The thickness of the protection films 420 and 430 is between 20 μm and 200 μm. For example, the thickness of the internal protection film 420 is between 20 μm and 50 μm, and is preferably of the order of 50 μm. For example, the thickness of the external protection film 430 is between 50 μm and 200 μm, and preferably of the order of 150 μm. The thicknesses of the protection films 420, 430 could be inverted.

As an illustrative example, references marketed by Tesa such as Tesa® 61500 or Tesa® 64621, or also 3M™: 82600, 82601, 82603 or 82605 could be used.

According to one of the variants, the adhesive layer 410 is an ACF (“Adhesive Conductive Film”) for which the electrical conduction property acts vertically. Advantageously, with an ACF film, there is no need to perform the electrical interconnection step (i.e. from the creation of openings to the filling of the openings to form electrical pads 810).

A rolling step (lamination) can be performed to efficiently assemble the adhesive layer 410 with the substrate 200 and the individual microbattery 300. One of the protection films 420, 430 is removed prior to this rolling step. In general, rolling may be done under a vacuum or it may be under a controlled atmosphere. The assembly can be made under a vacuum at a temperature ranging from 50° C. to 150° C., for example from 50° C. to 120° C., for example of the order or 90° C., with a pressure of more than 1 bar and a velocity of less than 3 m/minute. According to one variant embodiment, adhesives cross-linked by UV insolation or fixed with simple pressure can be used, to avoid the use of a heating step.

According to another variant embodiment, the adhesive layer 410 is transferred by sealing on the front face of the substrate.

This transfer step guarantees mechanical and chemical protection of the microbatteries 300 during grinding operations of the back face of the substrate.

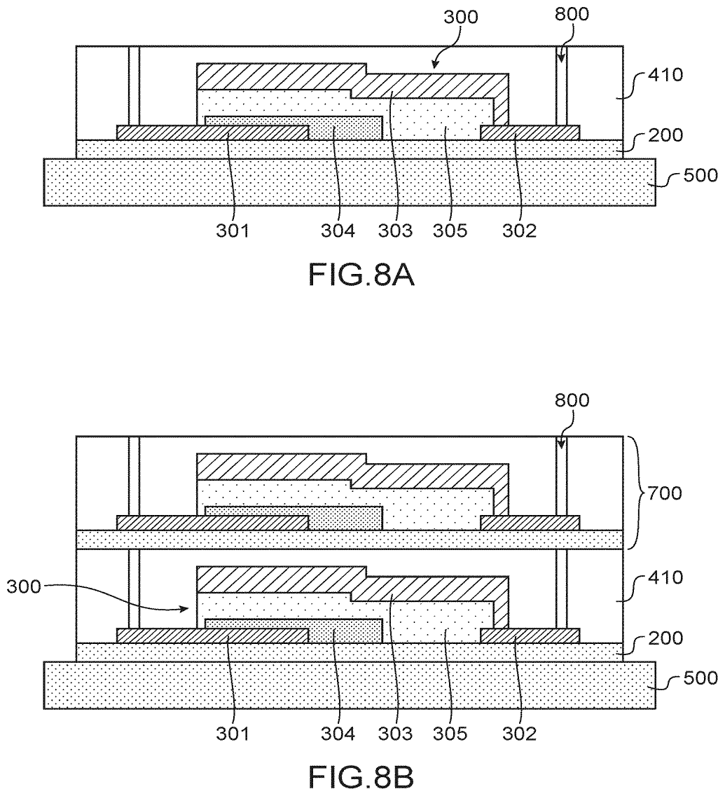

At the end of this step, the electrochemical device 300 and the substrate 200 are covered by the adhesive layer 410 and the external protection layer 430 (FIG. 4A).

According to one variant embodiment, the adhesive layer 410 is discontinuous so as to create cavities 450 facing the microbatteries (FIG. 4B).

According to one variant embodiment not represented, the adhesive layer 410 is hollowed out to create a cavity above the microbattery 300.

The presence of a free volume, obtained by a discontinuous adhesive layer 410 or by hollowing out the adhesive layer 410, eliminates the influence of variations of the unitary microbattery 300 related to the electrochemical activity between the two electrodes.

Each basic elementary structure comprises three elements: a substrate 200, the back face 202 of which can be thinned, a microbattery 300 or a set of microbatteries 300 arranged on the front face 201 of the substrate 200 and a double face adhesive layer 410 covering both the microbatteries 300 and the front face of the substrate 200.

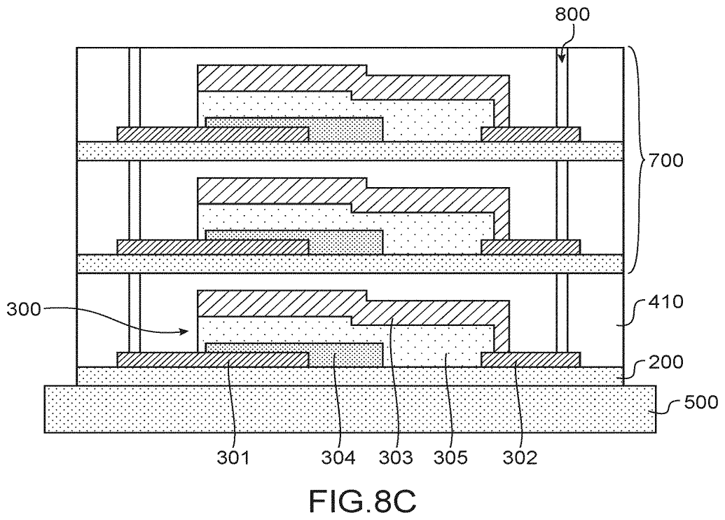

Following the transfer of the adhesive layer 410, access to the electrical contacts 301 and 302 of the microbattery 300 is made possible by the creation of two openings or passages 800 through the adhesive layer 410 and the external protection layer 430 (FIG. 5A).

Alternatively, the openings 800 can be made in the adhesive layer 410 before the adhesive layer 410 is transferred onto the substrate 200. According to a first alternative, the openings 800 form blind holes in the adhesive layer 410 (i.e. they do not pass through the adhesive layer 410 completely). According to another alternative, the openings 800 form through holes in the adhesive layer (i.e. they pass completely through the adhesive layer 410) and can possibly be prolonged into the external protection layer 430 so as to form blind holes (FIG. 5B).

According to another alternative, the openings 800 can be made once the different elementary structures have been stacked.

These openings 800 may for example be cylindrical in shape with a diameter of 50 μm. They can be made by laser etching opening up directly on the cathode 301 and anode 302 electrical contacts. More particularly, the range of available laser wavelengths varying from infrared (CO₂, Nd: YAG lasers, etc.) to ultraviolet light (Excimer laser and Nd: YAG harmonics) makes it possible to create hollow spaces in polymer films. For example, a CO₂ laser (10.4 μm wavelength) having a frequency of 1 ms, a power of 3 Watts and a displacement velocity of 10 mm/s is easily capable of excavating rectangular shapes (0.5 mm×0.5 mm) with a depth of 0.02 mm, stopping cleanly on the metal layers.

Step 3: Thinning of the Microbatteries Substrate:

This is the chemical grinding step of the external face of the rigid glass substrate 200. This step reduces the thickness of the substrate 200, for example, from 500 μm to 50 μm, while controlling the roughness with a TTV (“Total Thickness Variation”) having a value equivalent to the value of the substrate before thinning (about 1 μm). The thickness of the back face 202 is reduced while protecting the integrity of the microbatteries 300 located on the front face 201. The volume allocated to the packaging layers relative to the volume of the active layers is thus reduced.

To perform this step, the elementary structure is positioned inside a manipulation structure (or support) for thinning.

Manipulation structure 100:

As represented on FIG. 6, the manipulation structure 100 comprises an adhesive film 110 that will mechanically fix the substrate 200, fixed to a support frame 120 that enables manipulation of the structure 100.

The manipulation structure 100 is chemically inert to the etching solution used during step d). It is advantageously made of one or several polymer materials.

The adhesive film 110 comprises a first adhesive principal face 111, a second principal face 112 that may be adhesive or non-adhesive, opposite the first principal face 111, and a lateral face from the first principal face 111 to the second principal face 112.

The surface area of the adhesive film 110 is larger than the surface area of the substrate 200, making it easy to position the substrate 200 on the adhesive film 110.

The adhesive film 110 will be chosen to be resistant to the etching solutions used. For example, it will be resistant to acid solutions, in the case of a glass substrate.

The adhesive film 110 is preferably made of a polymer material.

The adhesive film 110 is preferably chosen for example from the family of films that can be activated by UV insolation, for example by pressure or by thermal heating. A thermally activable film can be used to implement the method with microelectronc devices sensitive to UV. The activation step of the adhesive film facilitates release of microelectronic devices during “back-end” processes.

The adhesive film 110 is preferably based on acrylic and/or polyester. For illustrative purposes, we can mention adhesive films 110 marketed by the 3M company under references « 3M™9085UV », “SP series” or “CP series” films marketed by the Furukawa Electric group company or “thermal release” films marketed by the Nitto company.

The thickness of the adhesive film 110 varies from 100 μm to 1 mm, for example of the order of 150 μm.

Advantageously, the adhesive 110 has a very strong bonding force (more than 1N/20 mm). Simple pressure is sufficient to bond the substrate 200 onto the adhesive film 110. Exposure of the adhesive film 110 to UV and/or thermal insolation is sufficient to reduce this bonding force (to bond values below 1N/20 mm).

The support frame 120 of the manipulation structure 100 is rigid, in other words it is self-supporting and it also resists the combined weight of the adhesive film 11 and the substrate 200 to be thinned. It can easily be manipulated.

It is manufactured from a material inert to chemical products used in etching solutions while thinning the substrate 200. It is preferably made of a polymer material.

It may be a material chosen from among polymers based on acrylate, polychloride, polycarbonate, polyethylene, mercapto ester, some epoxides, one of their derivatives or one of their copolymers.

The frame 120 can have different shapes (square, circular, rectangular, etc.).

It is preferably circular.

According to a first embodiment, the frame 120 is hollowed out and its shape advantageously corresponds to the shape of the periphery of the adhesive film 110). It is positioned on the first face 111 of the adhesive film 110. It is directly in contact with the first face 111, in other words they are adjacent. The internal walls of the hollowed out frame 120 and the first face 111 of the adhesive film 110 delimit a cavity. The external radius R of the frame 120 will be chosen by those skilled in the art as a function of the size of the substrate 200. The radius R will vary for example from 100 mm to 350 mm. The thickness A of the ring varying for example from 1 mm to 5 mm.

According to a second embodiment, the frame 120, hollowed out or not hollowed out, is positioned on the second face of the adhesive film. It is directly in contact with the second face 112, in other words they are adjacent. In this embodiment, the solution is less sensitive to any vibrations of the structure, due to chemical etching baths and rinsing methods.

The second face 112 of the adhesive film can be adhesive, so that the frame 120 can be bonded directly onto the adhesive film 110. In other words, an additional adhesive film can be used to combine the adhesive film 110 with the rigid frame 120, by bonding.

Optionally, attachment reinforcing elements (for example such as glues) can be added onto the adhesive film 110 and/or onto the frame 120 to improve the attachment.

The optional hollowing out of this frame can be made by chemical techniques or laser ablation techniques.

Use of a hollowed out frame 120 enables the use of several categories of adhesive films 110.

In general, a solid frame 120 makes it possible to use thermal adhesives.

In general, the dimensions (inside diameter, outside diameter, thickness) and the shape (circular, square, rectangular or other) of the frame 120 that may or may not be hollowed out, can be adapted with regard to the rigid substrates 200 used and the equipment used for chemical etching methods and for the “back-end” steps.

Attachment of the elementary structure to the adhesive film 410 consists of bringing the external protection layer 430 of the elementary structure into direct contact with the adhesive part of the film 111 of the thinning support (FIG. 6). In one preferred embodiment, contact between the adhesive part 111 and the external protection film 430 covering the substrate 200 and the microbattery 300 is made over the entire surface. Alternatively, this contact may be partial, for example in a few specific zones such as the periphery of the substrate 200.

The thinning operation of the back face 202 of the glass substrate 200 consists of immersing the substrate 200 bonding to the thinning structure in a chemical bath. Advantageously, an acid bath (pH<7) will be chosen, for example a mixture comprising 10% of HCl and 37% of HF heated to 25° C. Under such conditions, acid etching to thin the glass substrate by 150 μm (i.e. to change from an initial thickness of 500 μm to a final thickness of 50 μm), will last about 90 min. The assembly is then thinned with demineralised water and dried under air.

The presence of the adhesive layer 410, and the protection film 430, reinforces and prolongs the diffusion paths of etching products like HF. The protection film 430 acts as a sacrificial film during chemical thinning operations. It facilitates manipulation of the assembly before and/or after thinning.

After the thinning step of the back face 202 of the substrate 200, the ultrathin substrate 200 containing the microbatteries is released from the thinning support. This step can be implemented by performing one or several passes of a laser beam. The laser may be a picosecond laser in the visible range (530 nm), a CO₂ laser, a YAG laser, a femtosecond laser or an excimer laser. According to another variant embodiment, the separation step can be done using a mechanical sawing technique. This step can possibly be done by exposing the thinned face of the glass to a UV flux to dissociate the microbattery component 300 from the thinning support 100.

The thinned structures are advantageously released by a mechanical cutting method while keeping the adhesive tape 110 of the thinning support 100 attached to the external protection layer 430. The adhesive tape 110 of the thinning support 100 is then eliminated by a method called mechanical “peeling” of the external protection layer during the assembly process.

Alternatively, the elementary structure can be released from the manipulation structure 100 by detaching the external protection layer 430 from the adhesive layer 410.

The substrate 200 is released at the end of this step (FIG. 7).

The use of an adhesive layer 410 covered by an external protection layer 430 protects the microelectronic devices 300 during the etching step and facilitates the release of components after thinning.

Step 4: Vertical Assembly of the Microbatteries:

This step consists of vertically assembling the microbatteries 300 by transferring several elementary structures in a nested manner. The assembly may comprise two elementary structures or more than two elementary structures, for example three, four, five, six or seven elementary structures.

The assembly is made from a first elementary structure. The external protection film 430 of the adhesive layer 410 is removed by a mechanical operation (“peeling”).

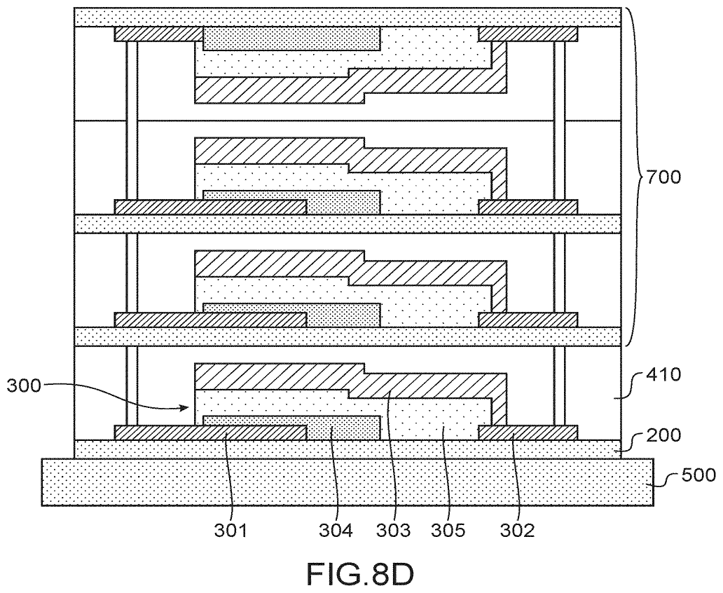

To facilitate this operation, the elementary structure can be held in place using a vacuum system such that the thinned face 202 of the substrate 200 can be held on a support 500, for example on a rolling tool support equipped with a vacuum system (FIG. 8A).

The second elementary structure can be transferred onto the first elementary structure using a rolling step, possibly under a vacuum, and/or by heating, for example to a temperature varying from 40° C. to 150° C., advantageously equal to 120° C. The protection film is then removed (FIG. 8B).

The bonding properties of the adhesive layer 410 are used to mechanically fix the individual structures and to stack them on each other in parallel. The second face of the adhesive layer 410 is judiciously positioned to receive the back face of the thinned substrate 200 of another structure.

Vertical superposition of the elementary structures is obtained by solidarisation and direct contact between the adhesive layer of an elementary structure and the upper elementary structure, positioned directly above. In other words, the second face of the substrate of an elementary substrate or the adhesive layer of an elementary structure is fixed directly to the adhesive layer of the subjacent elementary structure.

The operation can be iterated for a third time to fix a third elementary structure (FIG. 8C).

These steps will be reproduced as many times as necessary until the required number of stacked microbatteries is obtained.

In one preferred embodiment, the last elementary structure of the stack is positioned head to foot relative to the other elementary structures of the vertical stack (FIG. 8D). Advantageously, this embodiment increases encapsulation of the microbatteries.

The microbatteries are connected in parallel on FIG. 8D.

According to one embodiment, not represented, the microbatteries are electrically connected in series. To achieve this, electrical contacts with different polarities are aligned in the plane of the stack. A series connection coupled with a parallel connection could also be made.

Advantageously, the openings 800 opening up on the current collectors 301 and 302 are used not only to align the elementary structures with each other, but also to limit the formation of bubbles during the rolling process.

A laser process can be used to open the thinned substrates 200 of four individual structures at the passages 800 (FIG. 8E).

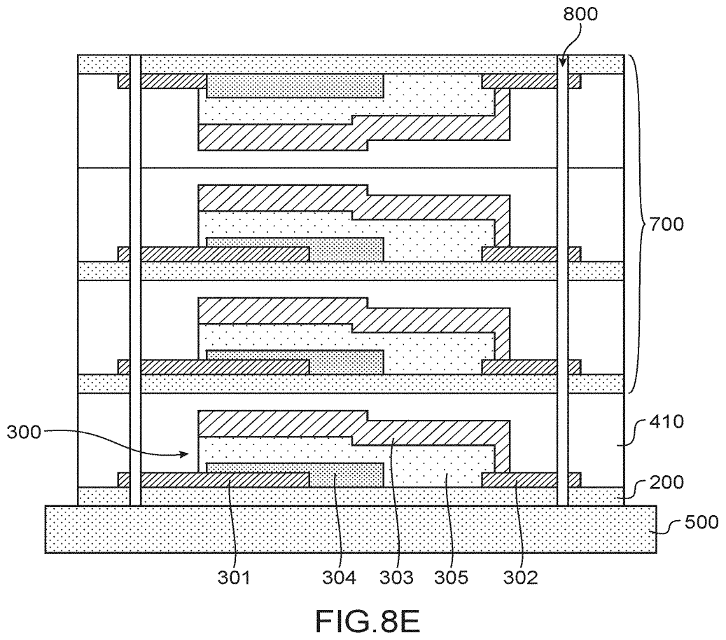

During a later step, electrically conducting pads 810 are formed, for example by filling in the passages 800 with an electrically conducting element that electrically connects the anode current collectors 302 at one end and the cathode current collectors 301 at the other end putting the four individual batteries in a parallel configuration (FIG. 9).

A heat treatment is advantageously performed to obtain pads with good electrical conduction.

Illustrative and non-limitative examples of one embodiment:

In this example, the thickness of the host substrate 200 is 500 μm and it is an AF32 glass from the alkali-free borosilicates family marketed by the SCHOTT company.

The microelectronic components 300 are microbatteries. The positive electrode is a 20 μm thick LiCoO₂ layer annealed at 600° C. for 10 h to obtain good crystallisation of the LiCoO₂ material. The electrolyte 305 is 3 μm thick LiPON. The negative electrode 303 is a 50 nm thick silicon layer.

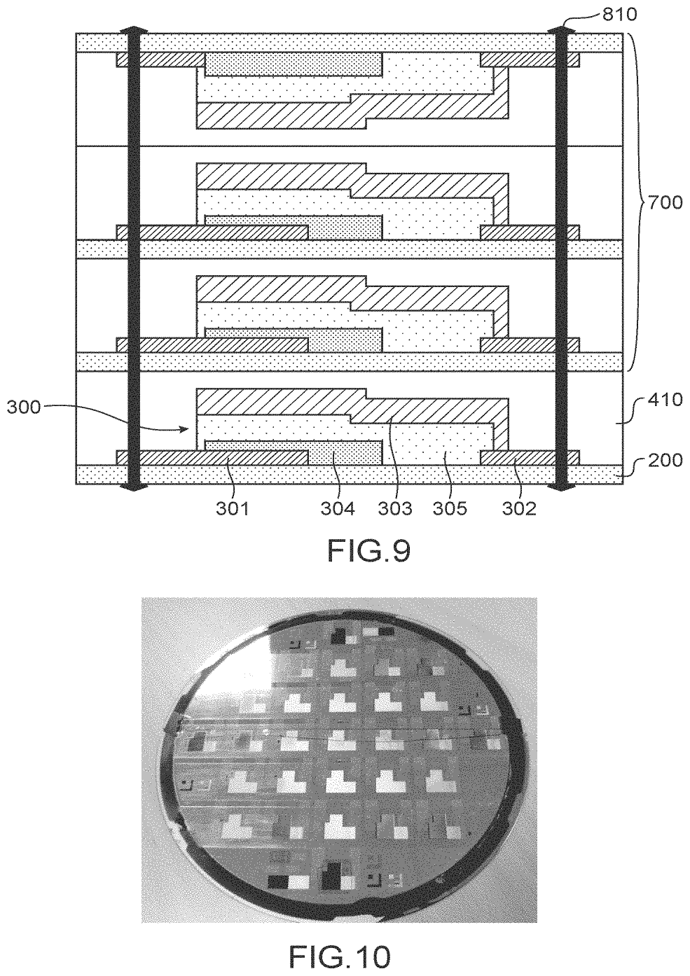

The adhesive layer 410 is a film marketed by Tesa under reference Tesa®61500. The protection layer 430 is based on PET. The adhesive layer 410 and its external protection layer 430 are rolled on the substrate 200. The assembly was made under a vacuum at a temperature of 90° C. with a pressure of more than 1 bar and a velocity of less than 3 m/minute. The assembly obtained is shown on FIG. 10.

The thinning support 100 comprises a hollowed out frame 120 made of PMMA with a circular shape and an outside diameter of 220 mm and a thickness of 4 mm, and positioned on a stretchable ribbon 100, the internal face of which is adhesive, with a thickness of about 110 μm.

The thinning step is done in an acid bath (pH<7), comprising 10% of HCl and 37% of HF and heated to 25° C., for about 90 min. The assembly is then rinsed with demineralised water and dried under air.

The ultrathin substrate 200 containing the microbatteries 300 is released from the thinning support by making 10 passes of a picosecond laser in the visible range (530 nm) at an energy of 50 μJ and a velocity of 20 mm/s.

The thinned back face of the first elementary structure is fixed on a support 500 of a rolling tool equipped with a vacuum system. The protection film 430 is then removed.

The second elementary structure is transferred onto the first elementary structure by a rolling step under a vacuum and by heating to a temperature of 90° C. at a pressure of more than 1 bar and a velocity of less than 3 m/minute. The external protection film 430 is then removed.

Before starting the step to make the electrical interconnection of the four individual microbatteries, a laser process is used to open the thinned substrates 200 of the four individual structures at the passages 800. The parameters are: picosecond laser in the visible range at 530 nm, about 50 passes at an energy of 50 μJ and a velocity of 20 mm/s.

The electrical interconnections are made by filling the openings 800 with a conducting liquid polymer, marketed by the Epo-Tek company under reference E4110, then performing an appropriate heat treatment. Electrical conduction pads 810 are obtained after a heat treatment at 150° C. for a duration of 15 minutes.

1. Method of thinning and encapsulating a microelectronic component, the method including the following steps:
supply of a substrate comprising a first principal face, a second principal face and a lateral face, the thickness of the substrate being more than 200 μm, and being covered by a microelectronic component and an adhesive layer, the adhesive layer being covered by a detachable protection layer; the substrate, the adhesive layer and the component forming an elementary structure,
fix the detachable protection layer onto a manipulation structure comprising an adhesive film and a support frame, the adhesive film comprising a first adhesive face and a second face opposite the first adhesive face, the detachable protection layer being arranged facing the first adhesive face of the adhesive film,
deposit a lateral protection layer on the lateral face of the substrate and on the periphery of the second face of the substrate, the lateral protection layer being in contact with the first adhesive face of the adhesive film, as a result of which the substrate is assembled with the manipulation structure,
thinning of the second principal face of the substrate to a thickness of less than 100 μm,
separation of the elementary structure from the manipulation structure.

2. Method according to claim 1, wherein the second principal face of the substrate is thinned to a thickness of less than 50 μm.

3. Method according to claim 1, wherein it also comprises the following steps:
separation of the detachable protection layer from the adhesive layer,
fixing an element on the adhesive layer of the elementary structure.

4. Method according to claim 3, wherein the element fixed on the adhesive layer is a cover.

5. Method according to claim 3, wherein the element fixed on the adhesive layer comprises one or several other elementary structures, so as to form a vertical stack with the first elementary structure, each elementary structure being fixed to the adhesive layer of the subjacent elementary structure.

6. Method according to claim 5, wherein an ultimate elementary structure is positioned on the vertical stack, the adhesive layer of the ultimate elementary structure being fixed to the adhesive layer of the subjacent elementary structure.

7. Method according to claim 1, wherein the method also comprises a step during which openings are formed through the adhesive layer so as to make the microelectronic component accessible, and a step in which the openings are filled by an electrically conducting material as a result of which electrically conducting contacts are formed.

8. Method according to claim 1, wherein the adhesive layer is an anisotropic conducting film.

9. Method according to claim 1, wherein the adhesive layer has a hollowed out part.

10. Method according to claim 1, wherein the adhesive layer is discontinuous so as to form a cavity for the microelectronic component.

11. Method according to claim 1, wherein the thickness of the adhesive layer is between 1 and 50 μm.

12. Method according to claim 1, wherein the adhesive layer is rolled onto the substrate.

13. Method according to claim 1, wherein the substrate comprises several microelectronic components.

14. Method according to claim 13, wherein the several microelectronic components are microbatteries.

15. Device comprising a vertical stack comprising a first elementary structure and a second elementary structure, each elementary structure comprising a substrate with a thickness of less than 100 μm, a first principal face of the substrate being covered successively by a microelectronic component, and by an adhesive layer, the second elementary structure being fixed to the adhesive layer of the first of an elementary structure, the adhesive layer being an anisotropic conducting film.

16. Device according to claim 15, wherein each elementary structure comprising a substrate with a thickness of less than 50 μm.

17. Device according to claim 15, wherein the vertical stack comprises an additional elementary structure, the adhesive layer of the additional elementary structure being positioned facing and fixed to the adhesive layer of the subjacent elementary structure.
